(19) United States
(12) Patent Application Publication
(10) Pub. No.: US 2010/0146992 A1
(43) Pub. Date: Jun. 17, 2010

(54) Insulation for storage or transport of cryogenic fluids

(76) Inventor: Thomas M. Miller, Holden, MA (US)

Correspondence Address: Tu N. Nguyen;CABOT CORPORATION, Law Department, 157 Concord Road, Billerica, MA, 01821, US

(21) Appl. No.: 12/653,065

(22) Filed: Dec. 8, 2009

Related U.S. Application Data
(60) Provisional application No. 61/121,371, filed on Dec. 10, 2008.

(51) Int. Cl. F17C 5/02; F17C 3/02; F17C 3/00; F25B 19/00; B23P 19/04; F17C 13/08

(52) U.S. Cl. 62/47.1; 220/560.12; 220/560.08; 62/51.1; 29/455.1; 62/53.2

(57) ABSTRACT

A vessel storing or transporting a low temperature fluid includes an insulating material disposed between an inner tank and an outer shell. The insulating material is volumetrically compressed so that it exerts a reaction force that is equal to or exceeds an ambient pressure at the outer shell and/or supports at least some of the weight of the inner tank. Manufacturing processes and methods of using the vessel also are described.

### RELATED APPLICATIONS

This application claims the benefit under 35 USC 119(e) of U.S. Provisional Application No. 61/121,371, filed on Dec. 10, 2008, which is incorporated herein by reference in its entirety.

### BACKGROUND OF THE INVENTION

Industrial gases are widely employed in plants, research laboratories and other facilities. Often, such gases are supplied as cryogenic liquids for low temperature applications or to be vaporized into the gaseous state at the point of use.

One mode of transportation for cryogenic liquids utilizes mobile trailers, pulled by vehicles, e.g., trucks. Such trailers generally are constructed as double-walled vessels having an inner tank for housing the cryogenic liquid and an outer shell.

In conventional trailers, structural strength is provided by the design of the inner tank and/or the outer shell and in many cases the annular space includes large numbers of structural reinforcements needed to support the weight of the inner tank and cryogenic cargo and to stiffen the outer shell against atmospheric pressure. These structural reinforcements, however, add to the weight of the trailer and often act as bridges for heat transfer between the cryogenic liquid and the surrounding environment. Furthermore, the need for their use adds considerable complexity to the design and manufacture of the vessel.

Typical insulating materials that have been used in cryogenic trailers include perlite, relatively soft yielding materials such as made of Kapok fiber or fiberglass batting.

Being in granular form, perlite conveniently can be poured into the space between the inner tank and outer shell. A problem that arises in conventional trailers employing perlite relates to the tendency of the material to settle. Settling often is exacerbated by vibrations generated during road travel and results in insulation losses. In turn, losses in insulation lead to inefficiencies caused by evaporation of cryogenic cargo and can raise safety concerns. In addition, perlite has a relatively high density, adding to the overall weight of the trailer.

While generally having a lower density than perlite, fiberglass batting often is secured around the inner tank or lined in the outer shell, thus complicating the manufacture of the trailer. Since in many cases care is taken to avoid compressing the fiberglass, portions of the batting can become loose during road travel, resulting in loss of insulation. Moreover, devices used to secure the fiberglass batting tend to add to the overall weight of the trailer.

Weight added to the annular space, e.g., large numbers of structural reinforcements and/or by the insulating material employed, can preclude a trailer from accessing certain roads or bridges. In many instances, the gross vehicle weight of the tractor, trailer, and cargo is limited by transportation regulations. Structural reinforcements of the inner and outer shell add weight to the trailer and limit the amount of cryogenic liquid cargo that it can carry.

### SUMMARY OF THE INVENTION

A need continues to exist, therefore, for improvements in trailer design and manufacture. A need also continues to exist for improved methods for the storage and/or transportation of cryogenic liquids.

In one embodiment, a vessel for storing or transporting a low temperature fluid includes an insulating material disposed between an inner tank and an outer shell, the insulating material being volumetrically compressed so that it exerts a reaction force that is equal to or exceeds an ambient pressure at the outer shell.

In another embodiment, a vessel for storing or transporting a low temperature fluid includes a volumetrically compressed insulation in an annular space between an inner tank and an outer shell, the volumetrically compressed insulation supporting at least some of the weight of the inner tank.

In a further embodiment, a vessel for storing or transporting a low temperature fluid includes an insulator in an annular space between an inner tank and an outer shell, the inner tank having a cylindrical cross-section and the outer shell having a non-cylindrical cross-section.

In yet another embodiment, a vessel for storing or transporting a low temperature fluid includes a volumetrically compressed insulator in an annular space between an inner tank and an outer shell, said outer shell having at least one flexible zone.

Aspects the invention also are directed to a method for transporting a low temperature fluid, the method comprising moving a vessel containing said fluid, wherein the low temperature fluid is surrounded by a volumetrically compressed insulator.

In further aspects, a method for storing a cryogenic fluid includes holding cryogenic fluid in a tank surrounded by a volumetrically compressed insulator.

Implementations of the invention also are directed to a process for manufacturing a vessel for storing or transporting a cryogenic fluid, the process comprising surrounding an inner tank with a volumetrically compressed insulator.

In yet another implementation, a process for manufacturing a vessel for storing or transporting a cryogenic fluid includes arranging an inner tank within an outer shell, and volumetrically compressing an insulator in a space between the inner tank and the outer shell.

Examples of insulating materials include nanoporous materials such as, for example, aerogel materials. Forces, e.g., weight support, or forces reacting against ambient pressure, can be distributed forces, acting over an area that exceeds a localized region such as a region defined by a structural reinforcement employed to support the inner tank or the outer shell.

Embodiments of the invention provide improved insulation combined with mechanical strength, increasing the overall efficiency of storing and/or transport of cryogenic or other low temperature fluids. The increased mechanical strength helps to reduce or eliminate requirements for structural reinforcements in the annular space. In specific examples mechanical support for the inner tank is provided by the insulating material, e.g., aerogel particles, which is installed at a high level of residual compression and can transfer the load of the inner tank to the outer shell and/or the structural frame of the trailer. This reduces or eliminates the need for mechanical weight supports and problems introduced by their undesirable weight and potential thermal short circuits of the trailer. In contrast to conventional granular materials such as perlite pellets that tend to be crushed under load bearing conditions, materials employed in many embodiments of the invention have spring-back properties and can be used repeatedly as the cargo is filled, emptied and re-filled.

In some examples, the thickness of the outer shell of the trailer can be reduced. In others, the outer shell can be a membrane or a membrane-like layer. Advantageously, outer shells can be fabricated from light-weight materials such as thin gauge metal or glass fiber composites, reducing the overall weight of the trailer. Trailers according to specific embodiments of the invention have low weight, increasing the amount of cargo that can be transported and/or allowing trailer access to additional roads or bridges.

Trailers in which the outer shell is supported by insulating materials such as aerogel, rather than by its own inherent strength, can be designed to vary the thickness of the annular space. For example, a thinner insulator gap can be used laterally, to minimize the overall width of the trailer, e.g., to within the standard size of over-the-road transport. A thicker insulation gap can be provided in other regions of the trailer, for instance at locations where fill, vent and/or drain pipes run alongside the tank. In some embodiments, aerogel insulation can be added to specific locations, e.g., locations that need additional insulation and/or increased mechanical strength, thereby reducing the overall amount of aerogel used.

Because the inner tank of a typical trailer will contract and expand due to temperature fluctuations as the tank is filled and emptied with cryogenic fluid, trailers which utilize a compressible and resilient material such as aerogel avoid problems of insulation settling or gaps forming in the insulation. This advantage is enhanced if the outer shell is flexible or resilient or contains a flexible element to allow it to contract and expand with the inner tank.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIG. 1 is an illustration of a typical tractor trailer truck suitable for over the road transport of a trailer containing cryogenic fluid.

FIG. 2 is a longitudinal elevational view, taken partly in cross-section, of a double walled vacuum storage vessel employing conventional non-compressed fiberglass batting.

FIG. 3 is plot of stress (Pa) versus strain percent of a sample of non-opacified Nanogel® aerogel TLD302 subjected to a single mechanical compression stroke test.

FIG. 4 is plot showing stress (MPa) versus strain percent of a sample of non-opacified Nanogel® aerogel TLD302, illustrating the high pressure compression behavior of the sample at two different temperatures.

FIG. 5 is a longitudinal cross-sectional view of an embodiment of the invention.

FIG. 6 is a transversal cross-sectional view of a further embodiment of the invention.

FIG. 7 is a longitudinal cross-sectional view of another embodiment of the invention

### DETAILED DESCRIPTION OF THE PREFERRED EMBODIMENTS

The above and other features of the invention including various details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

The invention generally relates to the storage and/or transportation of fluids held at low temperatures and in particular to cryogenic fluids.

Generally, the term “cryogenic” is used to describe low temperatures, for example in the range of from absolute zero to about 123° Kelvin (K) or −150° centigrade (C). A “cryogenic fluid” may be a liquid or a gas at a low temperature, for example a temperature that is less than approximately 123° K. In specific examples, the cryogenic fluid boils at a temperature less than approximately 110° K. at atmospheric pressure. Although these definitions are adequate for many applications, the terms are used herein to be consistent with other definitions accepted by those skilled in the art.

Examples of cryogenic fluids include nitrogen, oxygen, hydrogen, carbon dioxide, carbon monoxide, inert gases such as helium, argon, xenon, and mixtures thereof. The invention also can be practiced with liquid propane, liquefied petroleum gas, liquid carbon dioxide, liquefied natural gas (LNG) and with other fluids that are kept at a low temperature during storage or transportation. As used herein, the term “low temperature fulids” refers to fluids kept at a temperature of about −40° C. or lower.

Low temperature fluids often are stored and transported in Dewar-like vessels for instance in trailers that are truck- or tractor-pulled, railroad cars, hulls, aircraft chambers, as well as other tankage arrangements, e.g., those designed for mobile transport.

To reduce energy transfer, an insulating layer can be disposed around a tank containing the fluid. In double wall arrangements, the insulator can be disposed in a space or gap between an inner tank, holding the low temperature fluid, and an outer shell. This space also is referred to herein as “annular space” or “evacuable space”.

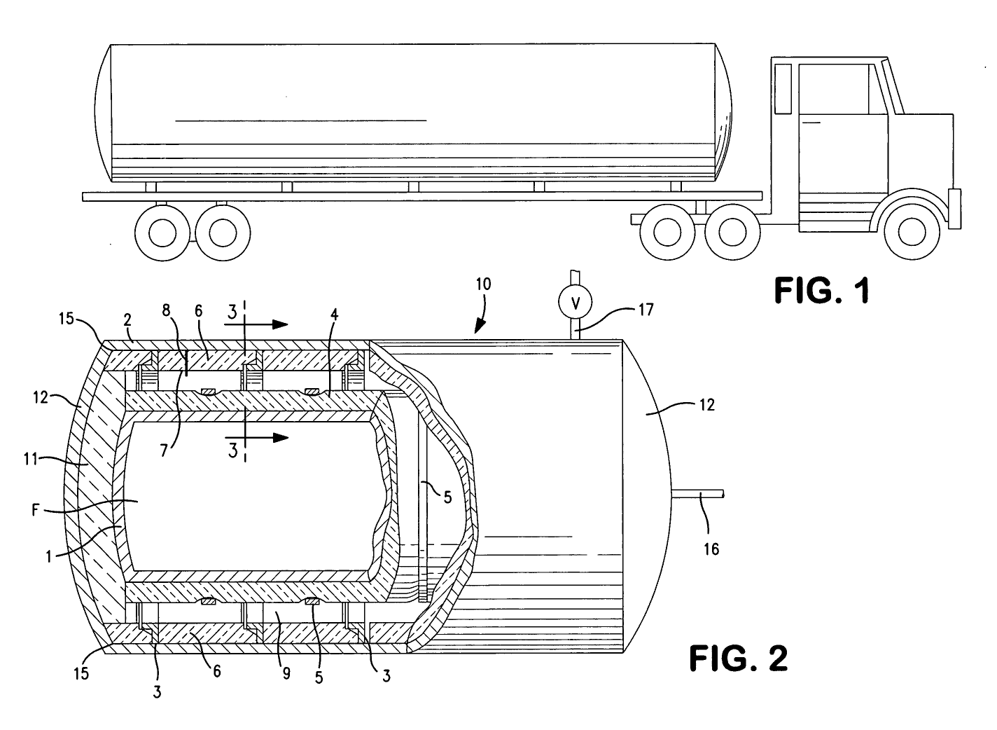

A typical tractor trailer truck for transporting cryogenic fluid is illustrated in FIG. 1.

Shown in FIG. 2 is cryogenic vessel 10 including inner tank 1, for holding a cryogenic fluid and outer shell 2 surrounding inner tank 1 in spaced relation thereto. Both the inner tank and the outer shell may be fabricated from two or more cylindrical sections.

Parameters considered in fabricating inner tank 1 and/or outer shell 2 include the reactivity or corrosive properties of the fluid being transported, pressures differentials exerted on the tank and shell, and so forth. In a typical conventional trailer, inner tank 1 and outer shell 2 are made of stainless steel or aluminum and carbon steel or aluminum, respectively.

The thickness of the inner tank walls is selected to withstand internal pressurization caused by the leakage of heat into the low temperature or cryogenic fluid. The magnitude of this pressure is generally limited by a conventional relief valve 17 that communicates with the cryogenic fluid F inside vessel 1. To reduce the overall weight of the trailer, it may be desired to utilize an outer shell that is as thin as possible.

To support outer shell 2 against its own weight and against the force of the atmospheric pressure imposed by evacuation of void space 9, a series of support members 3, which in FIG. 2 are structural L-rings, are axially-spaced along the inner wall of shell 2. External supports often are avoided since they exert unnecessary drag on the vessel during transportation. T-shaped or other types of support rings can also be used.

In a conventional approach, fiberglass batting insulation is used in a non-compressed form so as to maximize its insulation effectiveness at high vacuum, while minimizing the quantity and therefore, the weight of insulation used. In this approach, inner tank 1 is substantially non-compressively wrapped with a single layer of fiberglass batting 4, held in place on the inner tank by means of metal bands 5, which extend laterally around the insulation. Ordinary steel strap material, as commonly used in the packaging industry, wires or other means can be employed. In some arrangements, layer 4 is held in place at intervals with only as much force as is necessary to keep it from sliding off the inner tank during acceleration of the trailer. As a result, the overall density of the insulation is not substantially affected.

One function of layer 4 is to shield the inner ends of the support members 3 from the inner tank 1. Absent such shielding, significant amounts of heat would be transferred to the inner tank by conduction from supports 3.

A single layer of fiberglass batting 6 is also attached to outer shell 2. Individual sections of layer 6 are inserted within the spaces forward between the axially-spaced support rings 3. Layer 6 is held in place on the upper walls of shell 2 by means of friction nut 7 attached to studs 8 that are welded to shell 2.

Often, the process of assembling the layers of insulation takes place with the vessel situated in a horizontal position, since the vessel is to be transported via large trailer-trucks or railroad cars and therefore will be situated in the horizontal position during transportation as well as while in use.

The thickness of layers 4 and 6 is such that a void space 9 is formed when inner tank 1 is positioned within outer shell 2. Void space 9 can be on the order of 0.25 to 1.25 inches in width, e.g., between about 0.5 to 1.0 inch in width. In many arrangements, void space 9 is evacuated to a high vacuum, i.e., below about 100 microns of mercury. The presence of void space 9 facilitates removal of inner tank 1 from outer shell 2.

After securing the insulation to inner tank 1 and outer shell 2, inner tank 1 is telescopingly placed into the shell. Once the inner tank has been completely inserted into the outer shell 2, the ends of the assembly may be provided with additional insulation 11, e.g., fiberglass batting, and the spherical end plates 12 of the assembly are welded to the outer shell 2 at 15.

In one technique using fiberglass batting secured to outer shell 2 and inner tank 1, gas is evacuated through the insulation secured to the inner tank 1 into void space 9 and gas is simultaneously evacuated through the insulation secured to the outer shell 2 into the void space. Therefore, the gas is evacuated through only one-half of the total insulation thickness (that insulation which is secured either to outer shell 2 or to inner tank 1) and then through void space 9, thereby yielding a relatively higher vacuum conductance when compared to a system in which the entire intermediate evacuable space is filled with insulation. In order to maintain desired vacuum levels, a molecular sieve adsorbent can be provided adjacent to inner tank 1 within the intermediate evacuable space as known in vacuum technology for cryogenic storage vessels. The molecular sieve adsorbent facilitates the evacuation process by removing additional gases and thereby shortening the evacuation time.

Once assembled, the vessel may be filled and emptied of cryogenic fluid by means of the filling and discharge port 16.

In contrast to the non-compressively secured fiberglass batting insulation found in the conventional design described above, aspects of the invention relate to a vessel in which at least some and in many cases all the insulating material employed is volumetrically compressed.

In specific implementations of the invention, the insulation, also referred to herein as “insulator” or “insulating material” is volumetrically compressed so that it exerts a reaction force that is equal to or exceeds an ambient pressure at the outer shell. Generally, the ambient pressure is the atmospheric pressure exerted on the outer shell of the vessel. Vessels also can be designed for storing cryogenic or other low temperature fluids in environments that are not at atmospheric pressure. In many examples, the reaction force is a distributed reaction force. As used herein, the term “distributed” refers to a force that acts over an area that exceeds a localized region such as defined, for example, by a structural reinforcement. In some implementations, the reaction force is distributed over the entire interior surface of the outer shell. In other implementations, the reaction force is distributed over a substantial portion of the interior surface of the outer shell, e.g., the entire upper region, or, if structural reinforcements are being employed, over a region between two or more structural reinforcements.

In other implementations, the insulator supports some and in many cases all of the static weight of the inner tank, which can be empty or can contain a low temperature fluid. For mobile applications, the insulator can also support some or all dynamic loads caused by or developed during movement of the vessel. In many examples, the support is distributed over an outer area of the inner tank that exceeds a localized region such as defined, for example, by a structural reinforcement. For instance, the volumetrically compressed insulator can provide support that is distributed over a substantial area of the outer surface of the inner thank, e.g., the entire bottom of the tank or, if structural reinforcements are being employed, an area between two or more such reinforcements.

In further implementations, the volumetrically compressed insulating material provides mechanical support against at least some of the weight of the inner tank, which can be empty or can be holding cargo (e.g., a cryogenic fluid) and also against the ambient pressure exerted at the outer tank.

A suitable insulator that can be utilized consists of, consists essentially of or comprises an aerogel material.

Aerogels are low density porous solids that have a large intraparticle pore volume. Generally, they are produced by removing pore liquid from a wet gel. However, the drying process can be complicated by capillary forces in the gel pores, which can give rise to gel shrinkage or densification. In one manufacturing approach, collapse of the three dimensional structure is essentially eliminated by using supercritical drying. A wet gel also can be dried using an ambient pressure, also referred to as non-supercritical drying process. When applied, for instance, to a silica-based wet gel, surface modification, e.g., end-capping, carried out prior to drying, prevents permanent shrinkage in the dried product. The gel can still shrinks during drying but springs back recovering its former porosity.

Product referred to as “xerogel” also is obtained from wet gels from which the liquid has been removed. The term often designates a dry gel compressed by capillary forces during drying, characterized by permanent changes and collapse of the solid network.

For convenience, the term “aerogel” is used herein in a general sense, referring to both “aerogels” and “xerogels”.

Aerogels typically have low bulk densities (about 0.15 g/cm³ or less, e.g., about 0.03 to 0.3 g/cm³), very high surface areas (generally from about 300 to about 1,000 square meter per gram (m²/g) and higher, e.g., from about 600 to about 1000 m²/g), high porosity (about 90% and greater, preferably greater than about 95%), and a relatively large pore volume (about 3 milliliter per gram (mL/g), e.g., about 3.5 mL/g and higher). Aerogels can have a nanoporous structure with pores smaller than 1 micron (μm). Often, aerogels have a mean pore diameter of about 20 nanometers (nm). The combination of these properties in an amorphous structure gives the lowest thermal conductivity values (e.g., 9 to 16 mW/m·K at a mean temperature of 37° C. and 1 atmosphere of pressure) for any coherent solid material. Aerogels can be nearly transparent or translucent, scattering blue light, or can be opaque.

A common type of aerogel is silica-based. Aerogels based on oxides of metals other than silicon, e.g., aluminum, zirconium, titanium, hafnium, vanadium, yttrium and others, or mixtures thereof can be utilized as well.

Also known are organic aerogels, e.g., resorcinol or melamine combined with formaldehyde, dendredic polymers, and so forth, and the invention also could be practiced using these materials.

Suitable aerogel materials and processes for their preparation are described, for example, in U.S. Patent Application No. 2001/0034375 A1 to Schwertfeger et al., published on Oct. 25, 2001, the teachings of which are incorporated herein by reference in their entirety. Other methods can be used to prepare suitable aerogel materials.

The aerogel material employed can be hydrophobic. As used herein, the terms “hydrophobic” and “hydrophobized” refer to partially as well as to completely hydrophobized aerogel. The hydrophobicity of a partially hydrophobized aerogel can be further increased. In completely hydrophobized aerogels, a maximum degree of coverage is reached and essentially all chemically attainable groups are modified.

Hydrophobicity can be determined by methods known in the art, such as, for example, contact angle measurements or by methanol (MeOH) wettability. A discussion of hydrophobicity in relation to aerogels is found in U.S. Pat. No. 6,709,600 B2 issued to Hrubesh et al. on Mar. 23, 2004, the teachings of which are incorporated herein by reference in their entirety.

Hydrophobic aerogels can be produced by using hydrophobizing agents, e.g., silylating agents, halogen- and in particular fluorine-containing compounds such as fluorine-containing alkoxysilanes or alkoxysiloxanes, e.g., trifluoropropyltrimethoxysilane (TFPTMOS), and other hydrophobizing compounds known in the art. Hydrophobizing agents can be used during the formation of aerogels and/or in subsequent processing steps, e.g., surface treatment.

Silylating compounds such as, for instance, silanes, halosilanes, haloalkylsilanes, alkoxysilanes, alkoxyalkylsilanes, alkoxyhalosilanes, disiloxanes, disilazanes and others are preferred. Examples of suitable silylating agents include, but are not limited to diethyldichlorosilane, allylmethyldichlorosilane, ethylphenyldichlorosilane, phenylethyldiethoxysilane, trimethylalkoxysilanes, e.g., trimethylbutoxysilane, 3,3,3-trifluoropropylmethyldichlorosilane, symdiphenyltetramethyldisiloxane, trivinyltrimethylcyclotrisiloxane, hexaethyldisiloxane, pentylmethyldichlorosilane, divinyldipropoxysilane, vinyldimethylchlorosilane, vinylmethyldichlorosilane, vinyldimethylmethoxysilane, trimethylchlorosilane, hexamethyldisiloxane, hexenylmethyldichlorosilane, hexenyldimethylchlorosilane, dimethylchlorosilane, dimethyldichorosilane, mercaptopropylmethyldimethoxysilane, bis{3-(triethoxysilyl)propyl} tetrasulfide, hexamethyldisilazane and combinations thereof.

The aerogel insulator can include one or more additives such as fibers, opacifiers, color pigments, dyes and mixtures thereof. For instance, a silica aerogel can be prepared to contain additives such fibers and/or one or more metals or compounds thereof. Specific examples include aluminum, tin, titanium, zirconium or other non-siliceous metals, and oxides thereof. Non-limiting examples of opacifiers include carbon black, titanium dioxide, zirconium silicate, and mixtures thereof.

Additives can be provided in any suitable amounts, e.g., depending on desired properties and/or specific application.

The aerogel insulator can be produced in granular, pellet, bead, powder, or other particulate form and in any particle size suitable for an intended application. For instance, the particles can be within the range of from about 0.01 microns to about 10.0 millimeters (mm), e.g., can have a mean particle size in the range of 0.3 to 3.0 mm.

Examples of commercially available aerogel materials in particulate form are those supplied under the tradename of Nanogel® by Cabot Corporation, Billerica, Mass. Nanogel® aerogel granules have high surface area, are greater than about 90% porous and are available in a particle size ranging, for instance, from about 8 microns (μm) to about 10 mm. Specific grades of suitable translucent Nanogel® aerogel include, for instance, those designated as TLD302, TLD301 or TLD100; specific grades of suitable IR-opacified Nanogel® aerogel include, e.g., those under the designation of IG303 or CBTLD103; specific grades of suitable opaque Nanogel® aerogel include, for instance, those designated as OGD303.

The aerogel insulator also can be produced in a monolithic shape, for instance as a rigid, semi-rigid, semi flexible or flexible structure, or as composites.

In many cases, the composite materials include fibers and aerogels (e.g., fiber-reinforced aerogels) and, optionally, at least one binder. The fibers can have any suitable structure. For example, the fibers can have no structure (e.g., unassociated fibers). The fibers can have a matrix structure or similar mat-like structure which can be patterned or irregular and random. Some composites comprising fibers are composites formed from aerogels and fibers wherein the fibers have the form of a lofty fibrous structure, batting or a form resembling a steel wool pad. Examples of materials suitable for use in the preparation of the lofty fibrous structure include fiberglass, organic polymeric fibers, silica fibers, quartz fibers, organic resin-based fibers, carbon fibers, and the like. The material having a lofty fibrous structure can be used by itself or in combination with a second, open-cell material, e.g., an aerogel material. For instance, a blanket can have a silica aerogel dispersed within a material having a lofty fibrous structure.

Other suitable composite materials include at least one aerogel and at least one syntactic foam. The aerogel can be coated to prevent intrusion of the polymer into the pores of the aerogel, as described, for instance in International Publication No. WO 2007047970, with the title Aerogel Based Composites, the teachings of which are incorporated herein by reference in their entirety.

In one specific example, the aerogel insulator is a cracked monolith such as described in U.S. Pat. No. 5,789,075, issued on Aug. 4, 1998 to Frank et al., the teachings of which are incorporated herein by reference in their entirety. Often, the cracks enclose aerogel fragments that are connected by fibers. Aerogel fragments can have an average volume of 0.001 mm³ to 1 cm³. In one composite, the aerogel fragments have an average volume of 0.1 mm³ to 30 mm³.

In another specific example, the aerogel insulator is a composite that includes aerogel material, a binder and at least one fiber material as described, for instance, in U.S. Pat. No. 6,887,563, issued on May 3, 2005 to Frank et al., the teachings of which are incorporated herein by reference in their entirety.

Other specific examples of aerogel insulators that can be employed are fiber-web/aerogel composites that include bicomponent fibers as disclosed in U.S. Pat. No. 5,786,059 issued on Jul. 28, 1998 to Frank et al., the teachings of which are incorporated herein by reference in their entirety. Such composites use at least one layer of fiber web and aerogel particles, wherein the fiber web comprises at least one bicomponent fiber material, the bicomponent fiber material having lower and higher melting regions and the fibers of the web being bonded not only to the aerogel particles but also to each other by the lower melting regions of the fiber material.

In further specific examples the aerogel insulator is provided as a sheet or blanket produced from wet gel structures, as described, for instance, in U.S. Patent Application Publication Nos. 2005/0046086 A1, published Mar. 3, 2005, and 2005/0167891 A1, published on Aug. 4, 2005, both to Lee et al., the teachings of which are incorporated herein by reference in their entirety.

Porous materials other than aerogels also can be employed. In specific examples, the material is a microporous or a nanoporous material. As used herein, the term “microporous” refers to materials having pores that are about 1 micron and larger; the term “nanoporous” refers to materials having pores that are smaller than about 1 micron, e.g., less than about 0.1 microns. Pore size can be determined by methods known in the art, such as mercury intrusion porosimetry, or microscopy. In specific implementations, the pores are interconnected giving rise to open type porosity. Specific examples of materials that can be employed include but are not limited to oxides of a metal such as silicon, aluminum, zirconium, titanium, hafnium, vanadium, yttrium and others, and/or mixtures thereof. In one implementation of the invention, the insulation consists of, consists essentially of or comprises fumed silica.

Combinations of materials, e.g., such as described above, also can be employed. For instance, the insulator can be produced from different types of aerogel materials e.g., in particulate and/or monolithic form, or by combining granular aerogels having different particle sizes. Furthermore, an aerogel insulator can be combined with materials such as perlite, fiber glass or others used in the conventional storage and/or transport of cryogenic fluids. In a specific example, the insulation includes aerogel in combination with microspheres, e.g., glass, ceramic or polymeric microspheres. In another example, the insulation includes aerogel in combination with fumed silica.

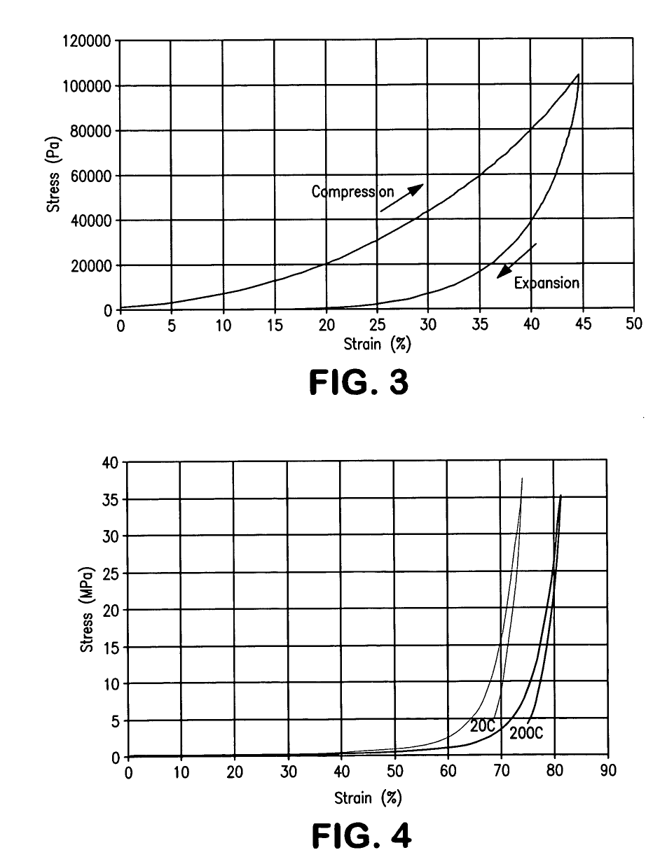

Specific implementations of the invention relate to using an insulator that is volumetrically compressible. Examples of volumetric compressibility are illustrated, for instance, in FIG. 3, which is a plot showing the single mechanical compression stroke test on a sample of non-opacified Nanogel® aerogel TLD302, and in FIG. 4, which is a plot of the high pressure compression behavior of non-opacified Nanogel® aerogel TLD302 at 20 degrees centigrade (° C.) and 200° C. Whereas the thermal conductivity of conventional materials tends to increase as the inter-particle air is squeezed out during volumetric compression, the thermal conductivity of some of the materials used in the insulation described herein, such as, for example, aerogel, remains the same or actually decreases with volumetric compression.

Under load bearing conditions, conventional granular materials such as perlite generally do not exibit spring back; rather, they tend to be crushed. In contrast, some of the insulating materials employed herein, e.g., aerogel, are resilient. By “resilient” it is meant that the compressible material will have an elastic compressibility, wherein application of a pressure to a bulk amount of the compressible material will result in a reduction of the volume occupied by the compressible material, and wherein, after release of the pressure, the volume of the compressible material will increase, and in many cases return to substantially the same value as before application of the pressure. In specific examples, the material consists of, consists essentially of, or comprises, e.g., 5% or more, aerogel, for instance, Nanogel® aerogel.

In many implementations of the invention, volumetrically compressed insulation occupies the entire annular space. In others, it is provided in specific regions or zones of the annular space.

Compressed insulators can be constructed from monolithic or composite materials such as aerogel blankets, cracked aerogel monoliths and so forth. In the annular space these materials are arranged so that they are compressed between an outer wall of the inner tank and an inner wall or the outer shell of the vessel.

In some embodiments of the invention, the space formed between the inner tank and the outer shell of a vessel, e.g., a trailer, contains a particulate insulating materials such as, for example, aerogel, e.g., Nanogel® aerogel. The material is volumetrically compressed and can occupy the entire annular space or regions thereof.

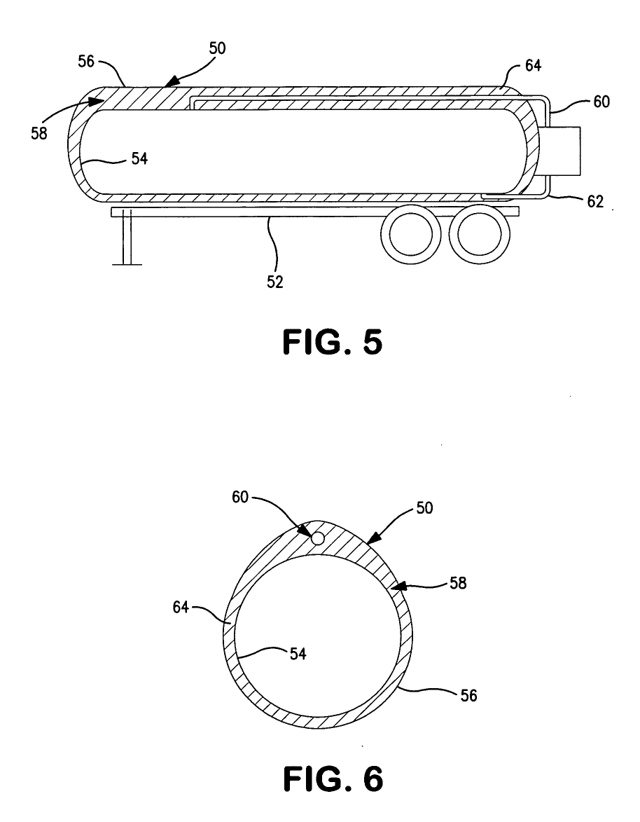

Shown in FIG. 5, for example, is vessel 50 supported by trailer chassis 52 and including inner tank 54 disposed within outer shell 56, with space 58 being formed between the inner tank and the outer shell. Inner tank 54 and/or outer shell 56 can be the same or different with respect to inner tank 1 and outer shell 2 described above with reference to FIG. 2, and can have a circular or non-circular transverse cross-section. Lines 60 and 62 are conduits, e.g., insulated pipes, for filling, draining and/or venting inner tank 54.

Space 58 contains volumetrically compressed insulator 64, e.g., in particulate form, e.g., aerogel granules. In many examples, the insulator is present in the entire space 58. In others cases, volumetrically compressed insulator is provided in specific sections of space 58. For example, aerogel insulator can be provided to support the bottom of the inner tank and/or can supplement or replace a conventional insulator in regions that require improved insulation, e.g., along fill, vent and/or drain lines 60 and/or 62.

In many cases, space 58 including volumetrically compressed insulator 64 is maintained at atmospheric pressure. Pressures other than atmospheric can be used. For example, the pressure can be less than atmospheric, less than 100,000 microns of mercury, less than 10,000 microns of mercury, less than 1,000 microns of mercury, less than 1,000 microns of mercury, less than 100 microns of mercury, less than 10 microns of mercury or less than 1 micron of mercury.

With respect to its uncompressed state, the insulation, e.g., aerogel material, can be compressed to a volume that is, for example, as little as 20 volume percent of the uncompressed volume of the insulation. In specific examples, compression results in a compressed volume that is within the range of from about 90, e.g., 65, to about 20 volume percent of the uncompressed volume. With respect to the tap density of a granular insulation, compression can result in a compressed density that is within the range of from about 125% to about 600% of the tap density of the uncompressed material. Tap density measurements can be conducted by techniques known in the art employing, for example standard testing methods.

In one example, granular Nanogel® aerogel is packed at a level of volumetric compression that at a minimum equalizes the force of the external atmospheric pressure. e.g., about 45% volumetric compression.

Using an insulator under residual compression can allow the inner tank, in many cases filled with low temperature fluid, to rest and to be supported by the insulator, which then transfers loads to the outer shell and/or the structural frame of the trailer, thus reducing or eliminating the need for structural reinforcements or decreasing their size and/or weight. For instance, structural reinforcement members (not shown in FIG. 5) supporting the outer shell can be spaced apart by distances larger than those employed in conventional cryogenic trailer designs.

In some implementations, the outer shell is supported by no more than an average of one structural reinforcement per meter, along the length of the vessel, e.g., trailer. In other implementations, no structural reinforcement members are employed to support outer shell 56; rather, the outer shell is entirely supported by the insulator disposed in space 58.

Utilizing an insulator under volumetric compression also can reduce the thickness of outer shell 56 and/or can allow fabricating outer shell 56 not only from conventional materials but also from materials, e.g., lighter materials, not employed in conventional vessels for storing and transport of low temperature fluids. Thus outer shell 56 can be made from steel, stainless steel, aluminum, thin gauge metal, rubber, glass fiber, glass fiber composites, polymeric films, fabrics and so forth. In some implementations, the outer shell, e.g., outer shell 56 in FIG. 5 is a thin or very thin un-reinforced membrane. In others, outer shell 56 has a thickness within the range of from about 1 millimeter (mm) and about 12 mm.

Embodiments in which the outer shell is supported by the compressed material, with little or no structural reinforcements, also facilitate using shells that are non-cylindrical, as well as arrangements in which a cylindrical inner shell is positioned off center with respect to a cylindrical outer shell, thereby creating an annular space that can vary in thickness from one location to another. For instance, more space and thus more insulation can be made available along fill, vent and/or drain lines.

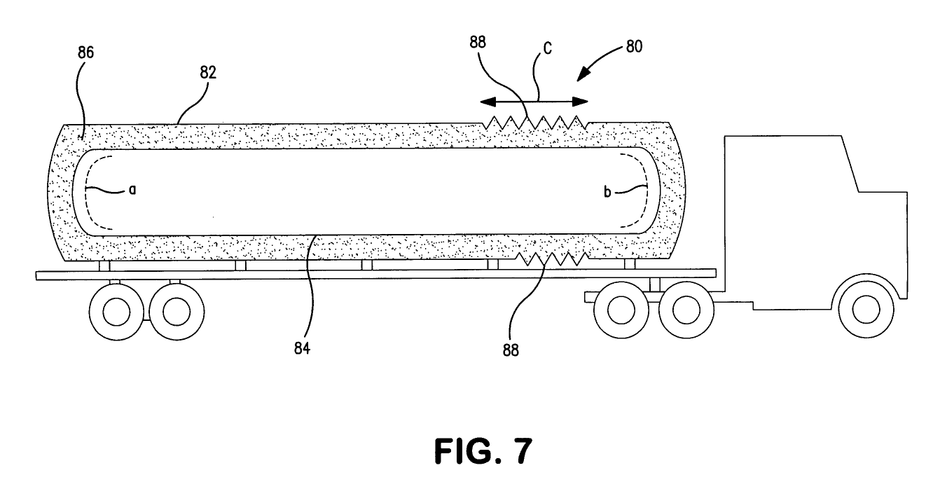

In one example, inner tank 54 is cylindrical while outer shell 56 has a non-cylindrical profile, as shown in FIG. 6. In this arrangement, thinner insulation levels are used laterally, reducing the overall width of the vessel, and higher levels of insulation are added at locations of increased likelihood of heat transfer, e.g. along fill, vent and/or drain lines 60.

Filling the inner shell with cryogenic fluid can be accompanied by contraction of the inner tank, resulting in an enlarged annular space and a possible decrease in the volumetric compression of the insulating material. In some cases, the drop in compression can result in diminished reactive force against the ambient, e.g., atmospheric, pressure exerted at the exterior of the outer shell.

Embodiments that can accommodate these changes include flexible outer shells. Flexibility can be provided, for example, by fabricating the outer shell from materials that have some elasticity, e.g., rubber, polymeric films, membranes, fabrics and the like. Bellows or other accordion-like structures can be employed to prevent shells made of thin rigid materials such as metal foil, from possibly collapsing towards the interior of the vessel. Shown in FIG. 7, for instance, is truck-pulled vessel 80 including outer shell 82, inner tank 84 and annular space 86 containing volumetrically compressed insulating material, e.g., granular aerogel. Contraction along the length of inner tank 84, caused by filling the tank with low temperature fluid, is illustrated broken lines a and b. To accommodate shrinkage, outer shell 82 includes at least one flexible zone, e.g., ring-like section 88, that can shrink or expand along its length, as indicated by arrow c. Section 88 can be made of bellows, other accordion-like device, telescoping arrangements and so forth.

Insulators that are volumetrically compressed can be used in combination with other insulating techniques and/or materials. For example, further to compressed insulating material in the annular space, one or both of the inner tank and the outer shell also can be insulated, e.g., an insulating material can be used to line the internal wall of the outer shell or can be wrapped around the inner tank. Additional insulation also can be provided by low pressure, vacuum and/or gas phase insulators. Furthermore, zones of the annular space, for example region(s) at the front and/or end of a trailer vessel or other regions, can be filled with uncompressed insulators such as fiberglass batting, perlite and so forth. In some embodiments, physical dividers can be employed to demarcate boundaries between different insulators or combinations thereof. Other combinations of arrangements can be utilized.

Additional inner tanks and/or outer shells can be provided in a vessel giving rise to further annular spaces. These annular spaces can contain aerogel in particulate, composite or monolithic form, other insulators, e.g., perlite, fiberglass, insulating gases such as argon, or can be maintained under vacuum. In some implementations, if further annular spaces are present in the vessel, they too contain a volumetrically compressed insulator.

The vessels described herein can be assembled by arranging the inner tank within the outer shell using manufacturing techniques known in the art. For instance, the inner vessel can be inserted into the outer shell or the outer shell can be moved to surround the inner tank. The telescopic disposition of the inner tank within the outer shell can be centered or can be any desired off-center arrangement. Once assembled, end plates can be provided and the vessel can be closed by known techniques, e.g., welding.

In practice the inner tank in a typical trailer can be approximately 35 feet in length, 6 feet in diameter and could hold approximately 7400 gallons of cryogenic liquid. A typical outer shell can be approximately 37 feet in length and 6 feet 8 inches in diameter. Techniques and equipment have been developed to handle the size and weight of such components during the assembly process. For example, procedures using external means, e.g., a sling held by a crane, to support the inner tank during at least part of the fabrication procedure are disclosed in U.S. Pat. No. 4,579,249, titled Fiberglass Insulation for Mobile Cryogenic Tankage, issued on Apr. 1, 1986 to Patterson et al., the teachings of which are incorporated herein by reference in their entirety. This reference teaches a rigid “U” shaped track, permanent or removable, that can be laid on support rings of the outer shell. The track can be provided with a groove or runner into which can slide a wheel assembly attached to the head of the inner tank; when engaged with the track, the wheel assembly provides additional support. The inner tank can be supported in spaced relation to the outer shell by any known load-rod design.

Alternatively, the track can be securely fastened onto the inner tank and a wheel assembly can be secured by suitable struts to some of the support rings. Optionally, one or more layers of insulation can be applied to the outer shell so as to fill the space between adjacent stiffening rings, yet still allow a suitable annular gap in the space for telescoping the inner tank within the outer shell. An additional layer of insulation can also be provided to shield the inner ends of the axially-spaced support members from the inner tank, so as to reduce conductive heat in-leakage.

Other suitable equipment and/or techniques can be used to position the inner tank, optionally insulated, within the optionally insulated outer shell.

Methods that can be employed to fill and/or pack the annular space, e.g., space 58 in FIG. 3, with particulate insulating material include those known in the art. For effective insulation, many of the filling and/or packing techniques utilized are those that result in reduced void formation, reduced settling and in uniform distributions of particles throughout the space being filled.

Vibration, tapping and/or tamping as well as other techniques can be employed to minimize void formation and/or settling and to ensure uniform insulation. Some techniques and equipment are described in U.S. Patent Application Nos. 20050074566 A1 and 20050072488 A1, both to Rouanet and published on Apr. 7, 2005 or International Publication Nos. WO 2005/032943 A2, and WO 2005/033432 A1, both published on Apr. 14, 2005. The teachings of these U.S. and PCT publications are incorporated herein by reference in their entirety.

Aerogel particles can be added to the annular space from a hopper while the assembly is being vibrated, e.g., at 60 Hz, until space 58 is visibly full. Alternatively the frequency can be varied, e.g., from 0 to 60 Hz, one or more times to increase the packing density of the particulate material. The frequency also can be varied from 0 to 120 Hz or higher.

Filling can be conducted in air or using a gas such as nitrogen or other inert gas. Filing also can be conducted at reduced pressure, for instance by removing air from the space 58 prior to and/or during filling. Filling rates can depend on factors such as filling port size, volume to be filled, material employed, and other criteria.

The vessel can be filled using techniques described in International Publication No. WO 2008/063954A1, published on May 29, 2008, with the title Mixing and Packing of Particles. One of the methods described in this publication relates to packing a particulate material in a volume and includes applying a negative pressure differential to the particulate material. In one example, the negative pressure differential is applied in the presence of a sound field. In another example, the negative pressure differential is applied in the presence of vibration field. The negative pressure differential also can be applied with a combination of both sound and vibration. The particulate material includes particles having a first particle size and particles having a second particle size, the first particle size being different from the second particle size.

Another method described in International Publication No. WO 2008/063954A1 relates to mixing particulate materials. The method includes applying a negative pressure differential to the particulate materials. In one example, the negative pressure differential is applied in the presence of a sound field. In another example, the negative pressure differential is applied in the presence of vibration field. The negative pressure differential also can be applied with a combination of both sound and vibration. The particulate material includes particles having a first particle size and particles having a second particle size, the first particle size being different from the second particle size. Particles having the first particle size can be combined with particles having the second particle size, e.g., by layering. In one example, fine particles are layered on top of coarse particles.

A further method described in this International Publication relates to increasing the packing density of a particulate material. The method includes combining a particulate material having a first particle size with a particulate material having a second particle size, wherein the first particle size is different from the second particle size, and applying a negative pressure differential in the presence of one or more of a sound field or a vibration field.

Particles having a first particle size and particles having a second particle size can have the same, similar or different chemical compositions. Particles within one particle size can include one or more chemical compositions.

To reduce or minimize settling and the formation of voids, space 58 can be “overfilled” or “overpacked”. Overpacked systems can have a density at least as high as the tap density. In the case of a trailer such as trailer 50, overfilling can be to greater than the tap density, for instance greater than about 100%, e.g., about 103 to about 115%-120% of the tap density. Higher packing results in stiffer mechanical properties.

Other techniques for filling at least a portion of the annular space include those disclosed in U.S. Pat. No. 6,598,283 B2, issued to Rouanet et al. on Jul. 29, 2003, the teachings of which are incorporated herein by reference in their entirety. U.S. Pat. No. 6,598,283 B2 describes, for instance, a method which includes providing a sealed first container comprising aerogel particles under a first air pressure that is less than atmospheric pressure. The unrestrained volume of the aerogel particles at the first air pressure is less than the unrestrained volume of the aerogel particles under a second air pressure that is greater than the first air pressure. The sealed first container then is placed within a second container, and the sealed first container is breached to equalize the air pressure between the first and second containers at the second air pressure and to increase the volume of the aerogel particles, thereby forming the insulation article.

In specific embodiments, particulate aerogel material is supplied to space 58 by methods and equipment described in U.S. Patent Application Publication No. 2006/0272727 A1, titled Insulated Pipe and Method for Preparing Same, to Dinon et al. published on Dec. 7, 2006, the teachings of which are incorporated herein by reference in their entirety.

For example, a method of manufacturing a vessel such as trailer 50 includes: (i) providing an assembly comprising (a) at least one inner tank, (b) an outer shell that is positioned around the at least one inner tank so as to create an annular space between the exterior surface of the at least one inner tank and the interior surface of the outer shell, and (c) at least one container comprising porous, resilient, volumetrically compressible material, wherein the compressible material is restrained within the container and has a first volume, wherein the first volume of the compressible material is less than the unrestrained volume of the compressible material, and wherein the at least one container is disposed in the annular space, and (ii) altering the at least one container to reduce the level of restraint on the compressible material to increase the volume of the compressible material to a second volume that is greater than the first volume, thereby forming the vessel.

The vessel, e.g., trailer 50, includes: (a) at least one inner tank with an exterior surface, (b) an outer shell with an interior surface that is disposed around the at least one inner tank, (c) an annular space between the interior surface of the outer shell and the exterior surface of the at least one inner tank, (d) a porous, resilient, compressible material disposed in the annular space, and (e) a remnant of a container that previously was positioned in the annular space and previously held the compressible material in a volume less than the volume of the compressible material in the annular space.

In a further example, a vessel such as trailer 50 comprises (a) at least one inner tank with an exterior surface, (b) an outer shell with an interior surface that is disposed around the at least one inner tank, (c) an annular space between the interior surface of the outer shell and the exterior surface of the at least one inner tank, and (d) a nanoporous material, e.g., silica aerogel, disposed in the annular space, wherein the nanoporous material has a density between 65 kg/m³ and about 200 kg/m³ and a thermal conductivity of about 22 mWmW/mK or less when measured between a surface at about 0° C. and a surface at about 25° C. at tap density and under standard atmospheric gas pressure.

In some implementations the insulating material, e.g., particulate aerogel, is provided to space 58 in one or more container(s) or pack(s). In some cases the container is manufactured to contain a particulate insulating material such as described above in a compressed state and to allow the material to expand upon alteration of the container, e.g., relaxation of forces restraining the container, as described in U.S. Patent Application Publication No. 2006/272727 A1, titled Insulated Pipe and Method for Preparing Same, to Dinon et al. published on Dec. 7, 2006, the teachings of which are incorporated herein by reference in their entirety.

No restrictions are placed on the configuration of the container. Accordingly, the container can have a rectangular- or parallelepiped-like geometry (e.g., a brick shape). It also can have a spherical or cylindrical shape.

In specific examples, the container has an elongate arched shape suitable for surrounding part of the inner tank. The elongate arched shape comprises a curve having generally a circular geometry defined by a cross section of the elongate arched container, wherein the angle defined by the two ends of the arch and the central point of the thus-defined semi-circle can be any nonzero value, e.g., greater than 0 to 360 degrees. In many cases, the elongate arched container has an angle no greater than 180 degrees (e.g., a “half shell”). In other cases, the arch of the elongate arched container has an angle of less than 360 degrees (e.g., about 355 degrees or less), in which the elongate arched container generally comprises a “C” shape, wherein the container has non-contiguous elongate edges that define a gap therebetween. To completely surround the inner tank, more than one container can be employed.

The container(s) can be provided with means that facilitate “mating” of the edges. For example, a pair of elongate mating edges can have complementary shapes so that the mating geometry can be any suitable mating geometry, including simple parallel faces. The mating edges can have a “tongue-in-groove” configuration, variations thereof or other suitable configurations.

During installation of the assembly, the container can be placed, for example, adjacent to the exterior surface of the inner tank and/or the interior surface of the outer shell prior to positioning of the inner tank and outer shell to form the annular space. Any suitable device, e.g., bands, fasteners and so forth can be employed to hold the container in place. In other examples, the inner tank and outer shell can be positioned to form the annular space prior to positioning the container(s) within the annular space.

When a plurality of containers is used, the containers can be positioned relative to each other such that gaps defined by the edges of the containers will not be coincident and thereby provide energy transfer passages between the inner tank and the outer shell. By way of illustration, when several elongate arched containers are employed and placed end-to-end and coextensive with the exterior surface of the inner tank, the gaps defined by the adjacent elongate edges of containers placed along one section of the inner tank desirably are staggered with respect to the gaps defined by the adjacent elongate edges of containers placed along an adjacent section of the inner tank. Similarly, if multiple layers of containers are utilized in the radial direction between the inner tank and outer shell, the edges of the container(s) of the one layer are staggered with respect to the edges of the container(s) of an adjacent layer. In this manner, any potential channels that may result from incomplete filling of the gaps with the particulate material after altering the containers desirably would not extend for more than the length of any one container in any direction within the annular space.

In addition to the insulating material, the one or more container(s) can include any suitable gas or can be under vacuum. Typically, the gas is air. However, in some embodiments the gas can be a gas having a lower thermal conductivity than air. Examples of such gases include argon, krypton, carbon dioxide, hydrochlorocarbons, hydrofluorocarbons, hydrochlorofluorocarbons, perfluorohydrocarbons, ethane, propane, butane, pentane, and mixtures thereof.

To prepare the vessel, the container can be altered as described in U.S. Patent Application Publication No. 2006/272727 A1.

Preferably, alteration refers to any operation that allows the compressible material to expand. For instance, a container can comprise a porous, resilient, and volumetrically compressible material, e.g., aerogel, wherein the compressible material is restrained within the container and has a first volume, wherein the first volume of the compressible material is less than the unrestrained volume of the compressible material. When the container is altered, the compressible material will expand to a second volume that is greater than the first volume.

Thus a suitable method for preparing vessel 50 includes (i) providing an assembly comprising (a) at least one inner tank, (b) at least one outer shell that is positioned around the at least one inner tank so as to create an annular space between the exterior surface of the at least one inner tank and the interior surface of the outer shell (and optionally additional annular spaces between the exterior surface of an outer shell and the interior surface of an additional outer shell), and (c) at least one container comprising porous, resilient, volumetrically compressible material, wherein the compressible material is restrained within the container and has a first volume, wherein the first volume of the compressible material is less than the unrestrained volume of the compressible material, and wherein the at least one container is disposed in the annular space (or one or more of the annular spaces in the event more than one outer pipe is utilized), and (ii) altering the at least one container to reduce the level of restraint on the compressible material to increase the volume of the compressible material to a second volume that is greater than the first volume, thereby forming vessel 50.

Another suitable method of preparing vessel 50 comprises (i) providing at least one inner tank with an exterior surface, (ii) providing at least one an outer shell with an interior surface that is positioned around the at least one inner tank (or outer shell) so as to create an annular space between the exterior surface of the inner tank and the interior surface of the outer shell (and/or the exterior surface of an outer shell and the interior surface of another outer shell), (iii) providing at least one container comprising porous, resilient, volumetrically compressible material, wherein the compressible material is restrained within the container and has a first volume, and wherein the first volume of the compressible material is less than the unrestrained volume of the compressible material, (iv) positioning the at least one container so that it ultimately is disposed in the annular space(s), and (v) altering the at least one container to reduce the level of restraint on the compressible material to increase the volume of the compressible material to a second volume that is greater than the first volume, thereby forming the vessel, wherein steps (i)-(iv) can be carried out in any suitable order.

The container also can be altered by modifying the pressure within the container, preferably from a lower initial pressure to a higher final pressure. In the initial state, the compressible material within the container is restrained to a compressed volume by the higher pressure surrounding it. Equalization of the gas pressure in the container with the gas pressure in the annular space, allows compressible material within the container to expand to a greater volume.

Any suitable techniques can be employed to breach the container and increase the volume of the compressible material held within. Examples are described in U.S. patent Application Publication No. 2006/272727 A1.

The volume of the container(s) before altering the container(s) is less than or equal to the volume of the annular space. Typically, the volume of the container(s) before altering the container(s) is about 99% or less (e.g., about 95% or less, or about 90% or less, or about 85% or less) of the volume of the annular space. Preferably, the volume of the container(s) before altering the container(s) is about 70% or more (e.g., about 80% or more, or about 85% or more) of the volume of the annular space. The volume of the container(s) is typically chosen based on the configuration of the container(s) and on the degree to which the compressible material will remain compressed after alteration of the container(s).

The difference between the first volume of the compressible material under restraint and the unrestrained volume of the compressible material is representative of the amount of compression the compressible material is subjected to when enclosed within the container(s). Typically, the first volume of the compressible material under restraint is about 80% or less (e.g., about 70% or less, or about 60% or less, or even about 50% or less) of the unrestrained volume of the compressible material.

After altering the container(s) to reduce the level of restraint on the compressible material, the compressible material desirably substantially fills the annular space. As noted above, the compressible material preferably will expand within the annular space and will fill any voids within the annular space, thus providing a substantially uniform distribution of the compressible material within the annular space.

In one embodiment, the compressible material, after altering the container(s), has substantially the unrestrained volume of the compressible material, which volume is substantially the volume of the annular space.

In another embodiment, the first volume of the compressible material in the container(s) is about 70% or less of the volume of the unrestrained volume of the compressible material, (b) the first volume of the compressible material in the container(s) is less than the volume of the annular space (e.g., about 99% or less, or about 95% or less), and (c) the second volume of the compressible material in the annular space after altering the container(s) is greater than or equal to about 1%, (e.g., 10%-33%) less than the unrestrained volume of the compressible material.

In yet another embodiment, the compressible material, after altering the container(s), has an unrestrained volume that is about 1% or more, for instance, about 10% or more (e.g., about 20% or more, or about 30% or more) greater than the volume of the annular space. In other words, the second volume of the compressible material in the annular space after altering the container(s) is at least about 9% (e.g., at least about 17%, or at least about 23%) less than the unrestrained volume of the compressible material. That is, the compressible material desirably would overfill the annular space after altering the container(s) if not for the restraint on the compressible material by the inner tank and outer shell.

The assembled vessel can be filled with low temperature fluid and the fluid can be stored or transported for further use.

While this invention has been particularly shown and described with references to preferred embodiments thereof, it will be understood by those skilled in the art that various changes in form and details may be made therein without departing from the scope of the invention encompassed by the appended claims.

What is claimed is:

1. A vessel for storing or transporting a low temperature fluid, the vessel comprising an insulating material disposed between an inner tank and an outer shell, the insulating material being volumetrically compressed so that it exerts a distributed reaction force that is equal to or exceeds an ambient pressure at the outer shell.

2. The vessel of claim 1, wherein the insulating material includes an aerogel.

3. The vessel of claim 1, wherein the insulating material includes a particulate material.

4. The vessel of claim 1, wherein the insulating material supports some or all of the inner tank static weight and, optionally, some or all of a dynamic load developed during motion of the vessel.

5. The vessel of claim 4, wherein the inner tank is filled with a low temperature fluid.

6. The vessel of claim 1, wherein the insulating material is compressed to a volume that is greater or equal to about 20 volume percent of an uncompressed volume of the insulating material.

7. The vessel of claim 6, wherein, the insulating material is compressed to a volume within the range of from about 90 volume percent and about 20 volume percent of the uncompressed volume of the insulating material.

8. The vessel of claim 1, wherein the outer shell is cylindrical.

9. The vessel of claim 1, wherein the outer shell is non-cylindrical.

10. The vessel of claim 1, wherein the outer shell is made from steel, stainless steel, aluminum, glass fiber, a polymeric film, rubber or fabric.

11. The vessel of claim 1, wherein the outer shell has a thickness within the range of from about 1 mm and about 12 mm.

12. The vessel of claim 1, wherein the vessel has no structural reinforcement for supporting the outer shell.

13. The vessel of claim 1, wherein the pressure between the inner tank and the outer shell is atmospheric pressure.

14. The vessel of claim 1, wherein the pressure between the inner tank and the outer shell is below atmospheric pressure

15. The vessel of claim 1, wherein the outer shell is supported by no more than an average of one structural reinforcement per meter along the length of the vessel.

16. A vessel for storing or transporting a low temperature fluid, the vessel comprising a volumetrically compressed insulation in an annular space between an inner tank and an outer shell, the volumetrically compressed insulation including a nanoporous material and providing distributed support for at least some of the weight of the inner tank.

17. The vessel of claim 16, wherein the insulation includes an aerogel.

18. The vessel of claim 16, wherein the insulation includes a particulate material.

19. The vessel of claim 16, wherein said insulation supports some or all of the inner tank static weight and some or all of a dynamic load developed during motion of the vessel.

20. The vessel of claim 19, wherein the inner tank is filled with a low temperature fluid.

21. The vessel of claim 16, wherein the insulation is compressed to a volume that is as greater or equal to about 20 volume percent of an uncompressed volume of the insulation.

22. The vessel of claim 21, wherein the insulation is compressed to a volume that is within the range of from about 90 volume percent to about 20 volume percent of the uncompressed volume of the insulation.

23. The vessel of claim 16, wherein the insulation exerts a reactive force equal to or exceeding an ambient pressure at the outer shell.

24. The vessel of claim 16, wherein the outer shell is cylindrical.

25. The vessel of claim 16, wherein the outer shell is non-cylindrical.

26. The vessel of claim 16, wherein the outer shell is made from steel, stainless steel, aluminum, glass fiber, a polymeric film, rubber or fabric.

27. The vessel of claim 16, wherein the outer shell has a thickness within the range of from about 1 mm and about 12 mm.

28. The vessel of claim 16, wherein the vessel has no structural reinforcement for supporting the outer shell.

29. The vessel of claim 16, wherein the pressure between the inner tank and the outer shell is atmospheric pressure.

30. The vessel of claim 16, wherein the pressure between the inner tank and the outer shell is below atmospheric pressure

31. The vessel of claim 16, wherein the outer shell is supported by an average of no more than one structural reinforcement per meter along the length of the vessel

32. A vessel for storing or transporting a low temperature fluid, the vessel comprising an insulator in an annular space between an inner tank and an outer shell, wherein the inner tank is cylindrical and the outer shell is non-cylindrical.

33. The vessel of claim 32, wherein the insulator is volumetrically compressed.

34. A vessel for storing or transporting a low temperature fluid, the vessel comprising a volumetrically compressed insulator in an annular space between an inner tank and an outer shell, said outer shell having at least one flexible zone.

35. The vessel of claim 34, wherein said flexible zone includes bellows.

36. A method for transporting a low temperature fluid, the method comprising moving a vessel containing said fluid, wherein the low temperature fluid is surrounded by a volumetrically compressed insulator that includes a nanoporous material.

37. The method of claim 36, wherein the volumetrically compressed insulator is in an annular space between an inner tank holding the cryogenic fluid and an outer shell.

38. The method of claim 36, wherein the method includes over the road or rail transport.

39. The method of claim 36, wherein said insulator is an aerogel material.

40. A method for storing a cryogenic fluid, the method comprising holding cryogenic fluid in a tank surrounded by a volumetrically compressed insulator that includes a nanoporous material.

41. The method of claim 40, wherein the tank is within an outer shell and said insulator is present in a space between an outer surface of the tank and an inner surface of the outer shell.

42. A process for manufacturing a vessel for storing or transporting a cryogenic fluid, the process comprising surrounding an inner tank with a volumetrically compressed insulator that includes a nanoporous material.

43. A process for manufacturing a vessel for storing or transporting a cryogenic fluid, the process comprising arranging an inner tank within an outer shell, and volumetrically compressing an insulator in a space between the inner tank and the outer shell, wherein the insulator includes a nanoporous material.

44. The process of claim 43, wherein the space between the inner tank and the outer shell is overfilled with said insulator.

45. A vessel for storing or transporting a cryogenic fluid the vessel comprising a volumetrically compressed insulation disposed between an inner tank and an outer shell and exerting a distributed force, the insulation including a material selected from the group consisting of fumed silica, aerogel or any combination thereof.

46. The vessel of claim 45, wherein the insulation further includes glass microspheres.
